(19) United States
(12) Patent Application Publication
(10) Pub. No.: US 2011/0286751 A1
(43) Pub. Date: Nov. 24, 2011

(54) OPTICAL TRANSCEIVER AND METHOD FOR CONTROLLING THE SAME

(76) Inventor: KATSUHIRO YUTANI, Tokyo (JP)

(21) Appl. No.: 13/103,906

(22) Filed: May 9, 2011

(30) Foreign Application Priority Data
May 20, 2010 (JP) P2010-116657

(51) Int. Cl. H04B 10/00

(52) U.S. Cl. 398/136

(57) ABSTRACT

An optical transceiver includes: an optical reception circuit which converts a first optical signal received from an optical cable into a first electrical data signal and outputs the first electrical data signal; an optical transmission circuit which converts a second electrical data signal into a second optical signal and outputs the second optical signal to the optical cable; a noise detection unit which detects power supply noise from a power supply voltage; and a control unit which sets at least one of operational characteristics of the optical reception circuit and operational characteristics of the optical transmission circuit in accordance with a detection result of the noise detection unit.

This application is based upon and claims the benefit of priority from Japanese patent application No. 2010-116657, filed on May 20, 2010, the disclosure of which is incorporated herein in its entirety by reference.

### BACKGROUND OF THE INVENTION

1. Field of the Invention

The present invention relates to optical transceivers which are each connected to an optical communication apparatus and to an optical cable and which realize transmission and reception of optical signals by converting electrical signals into optical signals and by converting optical signals into electrical signals, and a method for controlling the optical transceivers.

2. Description of the Related Art

Optical transceivers are optical transmission and reception modules each connecting between an optical communication apparatus and an optical cable bidirectionally. Optical transceivers realize transmission and reception of optical signals by converting electrical signals into optical signals and by converting optical signals into electrical signals. As FTTH (Fiber to the Home) services become widespread, the diffusion of optical transceivers is advancing. In addition, with respect to optical transceiver products, miniaturization, reduction in power consumption, realization of a single power-supply operation, and standardization are in progress.

However, as miniaturization and reduction in power consumption of optical transceiver products make progress, the characteristics of the optical transceiver products are increasingly affected by power supply noise components which are generated while the optical transceiver products are operated. For example, if noise is increased, the noise influences the reception characteristics of optical transceivers. Specifically, while an optical signal is received, the received optical signal is converted into an electrical signal, and determination is made as to whether the converted electrical signal indicates a “0” or a “1”, if noise is superposed on the electrical signal, the noise affects the accuracy of a determination threshold which is used in determining the data. Moreover, with respect to the transmission characteristics of optical transceivers, if power supply noise is superposed on, for example, a drive current of a semiconductor laser which is used for transmitting optical signals, frequency chirping is generated in the optical signals, which results in a factor of deteriorating the transmission characteristics. These influences are dependent on environments in which optical transceivers are operated as well as on power supply voltages fed from, for example, apparatuses in which the optical transceivers are installed. Therefore, they are key issues in matching the characteristics and the specifications between optical transceivers and apparatuses in which the optical transceivers are installed.

As a scheme for mitigating influences due to noise, there is a technique of installing a stabilization circuit and/or a regulator circuit in a power supply circuit. Moreover, as techniques of stabilizing power supply circuits, there are techniques as proposed in, for example, Japanese Unexamined Patent Application, First Publication No. 2008-92348 (hereinafter referred to as “Patent Document 1”) and Japanese Unexamined Patent Application, First Publication No. 2004-88638 (hereinafter referred to as “Patent Document 2”).

However, the scale of circuits is increased if the techniques as disclosed in Patent Document 1 and Patent Document 2 and employed and if a power supply voltage is stabilized by installing a stabilization circuit and/or a regulator circuit in a power supply circuit. Moreover, if a stabilization circuit and/or a regulator circuit are mounted in a power supply circuit, there is a possibility that an internal power supply voltage be dropped.

Under an operating environment in which an optical transceiver is installed in a transport apparatus which is provided in a network in which optical amplifiers are deployed, such as a WDM (Wavelength Division Multiplexing) apparatus, in addition to the generation of power supply noise, noise is generated by, for example, spontaneous emission light components which are generated in the propagation of an optical signal. Influences of such noise generated by the spontaneous emission light components cannot be ameliorated by stabilization circuits and regulator circuits.

Furthermore, optical transceivers are used in diverse environments, and hence noise is generated in various situations depending on environments in which an optical transceiver is used. As a result, the characteristics of an optical transceiver alone which are measured at the time of the shipment of the optical transceiver may be different from the characteristics of the optical transceiver when the optical transceiver is actually integrated into a system. For this reason, if an optical transceiver is operated with the optical transceiver actually integrated into the system, the optical transceiver is influenced by noise components. As a result, the optical transceiver cannot realize the performance measured at the time of its shipment, which may cause mismatches between specifications and may require a substantial time to find out solutions of problems.

In addition, as specifications with respect to data which is transmitted and received by optical transceivers, there are specifications such as those employed in SONET (Synchronous Optical Network), SDH (Synchronous Digital Hierarchy), and Ethernet (registered trademark). Application programs which run on apparatuses in which optical transceivers are installed are required to support these specifications. However, even if an attempt is made to employ optical transceiver products which have the same characteristics, it is difficult to ensure the characteristics that support all the application programs that run in accordance with the different specifications.

It is noted that a great number of optical transceiver products are appearing which support the setting of a determination threshold by apparatuses in which the optical transceiver products are installed. However, in such optical transceiver products, if an initial value of a determination threshold, which was set at the time of the shipment of an optical transceiver product, is changed to a value which is different from the initial value, it becomes difficult to ensure the characteristics of the optical transceiver product. In addition, with respect to the tolerance characteristics against power supply noise, which are defined as specifications for evaluating the characteristics of optical transceivers, reception characteristics and transmission characteristics have been evaluated using parameters such as the amplitude and the frequency of the power supply noise. However, standard techniques for such evaluation have not yet been established.

### SUMMARY OF THE INVENTION

The present invention has been made in light of the above problems, and an exemplary object of the present invention is to provide an optical transceiver that can optimally set the characteristics thereof in accordance with the level of detected noise, and a method for controlling the optical transceiver.

In order to solve the foregoing problems, an exemplary aspect of the present invention is an optical transceiver which includes: an optical reception circuit which converts a first optical signal received from an optical cable into a first electrical data signal and outputs the first electrical data signal; an optical transmission circuit which converts a second electrical data signal into a second optical signal and outputs the second optical signal to the optical cable; a noise detection unit which detects power supply noise from a power supply voltage; and a control unit which sets at least one of operational characteristics of the optical reception circuit and operational characteristics of the optical transmission circuit in accordance with a detection result of the noise detection unit.

Another exemplary aspect of the present invention is a method for controlling an optical transceiver, and the method includes: detecting power supply noise of an optical transceiver which is provided with an optical reception circuit which converts an optical signal received from an optical cable into an electrical data signal and outputs the electrical data signal, and an optical transmission circuit which converts an electrical data signal into an optical signal and transmits the optical signal to the optical cable; and setting at least one of operational characteristics of the optical transmission circuit and operational characteristics of the optical reception circuit in accordance with a detection result of the power supply noise.

In accordance with the exemplary aspects of the present invention, the noise detection unit, which detects the power supply noise, is installed in the optical transceiver. As a result, it is possible to optimally set the operating characteristics of the optical reception circuit (e.g., a data determination threshold) and the operating characteristics of the optical transmission circuit (e.g., a drive current of a laser diode) in accordance with the detection result of the noise detection unit. In addition, deterioration in characteristics due to the power supply noise can be maintained minimum. Moreover, the characteristics of the optical transceiver can be set optimally in accordance with environments in which the optical transceiver is used and the specifications between the optical transceiver and an apparatus in which the optical transceiver is installed. Furthermore, in order to evaluate the characteristics of products, standard specifications can be established by quantitatively detecting differences between operating environments with respect to power supply noise in which the optical transceiver is used. In addition, stable operating characteristics against power supply noise can be realized, independent of environments in which an apparatus installing the optical transceiver is used. In an evaluation for authorizing the optical transceiver, it is possible to reduce the dependency on the configuration of a network and application programs which run on an apparatus in which the optical transceiver is installed, and hence parameters and costs required for the evaluation can be reduced.

### BRIEF DESCRIPTION OF THE DRAWINGS

FIG. 1 is a block diagram showing the structure of an optical transceiver in accordance with a first exemplary embodiment of the present invention.

FIG. 2 is a block diagram showing an example of the structure of a noise detection unit provided in the optical transceiver when the noise detection unit is realized by an analog circuit.

FIG. 3 is a circuit diagram showing an example of the structure of a peak detection circuit provided in the noise detection unit.

FIG. 4 is an exploded perspective view showing an example of the structure of the optical transceiver in accordance with the first exemplary embodiment of the present invention.

FIG. 5 is a block diagram showing the structure of a main portion of the optical transceiver when noise detection in the optical transceiver is performed by a control unit.

### DETAILED DESCRIPTION OF THE INVENTION

Hereinafter, exemplary embodiments of the present invention will be described with reference to the appended drawings.

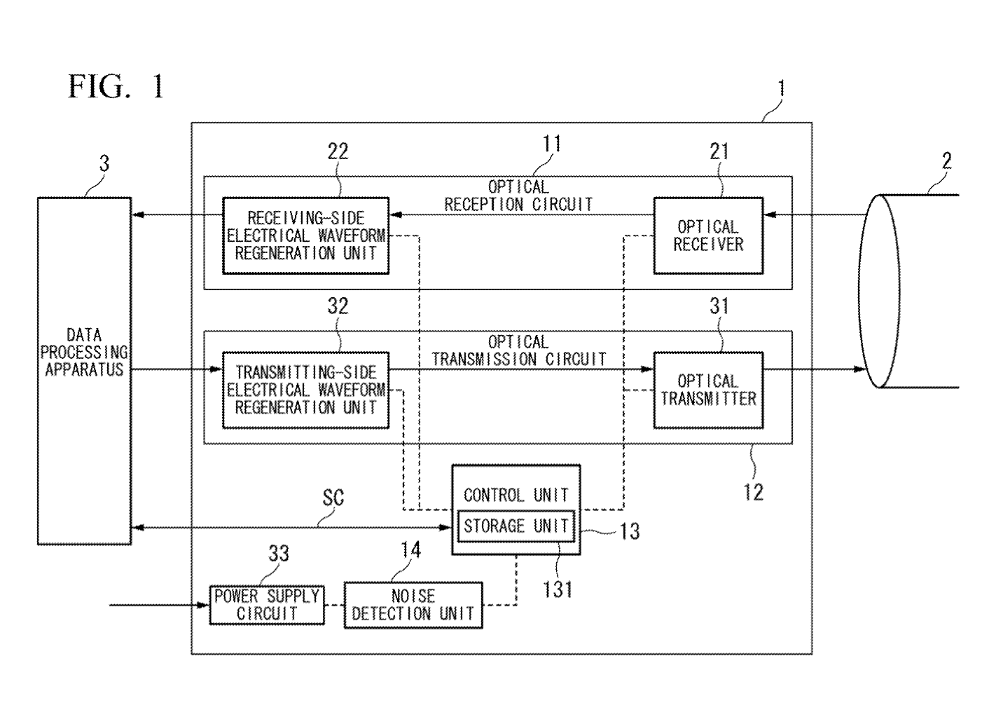

FIG. 1 is a block diagram showing the structure of an optical transceiver 1 in accordance with a first exemplary embodiment of the present invention.

As shown in FIG. 1, the optical transceiver 1 in accordance with the first exemplary embodiment of the present invention is provided with an optical reception circuit 11, an optical transmission circuit 12, a control unit 13, a noise detection unit 14, and a power supply circuit 33.

The optical reception circuit 11 receives an optical signal supplied from an optical cable 2, converts the received optical signal into an electrical data signal, and transmits the converted electrical data signal to a data processing apparatus 3. The optical reception circuit 11 is provided with: an optical receiver 21 which is configured by, for example, a photodetector; and a receiving-side electrical waveform regeneration unit 22 which compares an output signal supplied from the optical receiver 21 with a data determination threshold to determine whether the output signal indicates a “0” or a “1”, and outputs the determined data.

The optical transmission circuit 12 converts an electrical data signal supplied from the data processing apparatus 3 into an optical signal, and transmits the converted optical signal to the optical cable 2. The optical transmission circuit 12 is provided with: a transmitting-side electrical waveform regeneration unit 32 which regenerates the electrical data signal supplied from the data processing apparatus 3; and an optical transmitter 31, such as a laser diode, which converts an electrical data signal regenerated by the transmitting-side electrical waveform regeneration unit 32 into an optical signal, and transmits the converted optical signal.

The control unit 13 controls the optical reception circuit 11 and/or the optical transmission circuit 12. The control unit 13 is provided with a storage unit 131 which stores various items of data. The control unit 13 is configured by, for example, a microcomputer. The respective settings of the optical reception circuit 11 and the optical transmission circuit 12 can be performed under control of the control unit 13. The control unit 13 is also provided with: a function of communicating with apparatuses provided outside the optical transceiver 1 (e.g., the data processing apparatus 3) by means of serial communications as shown by reference symbol SC; and a function of monitoring each unit provided in the optical transceiver 1.

The noise detection unit 14 detects noise included in a power supply voltage fed from the power supply circuit 33, and transmits the detection result of the noise to the control unit 13. The control unit 13 optimally sets, for example, a data determination threshold of the receiving-side electrical waveform regeneration unit 22 provided in the optical reception circuit 11 and a drive current of the optical transmitter 31, such as a laser diode, provided in the optical transmission circuit 12 in accordance with the noise detection result supplied from the noise detection unit 14.

As will be described below in detail, a data determination threshold which is used in actual determination can be set in accordance with, for example, the level of noise. The control unit 13 pre-stores a data determination threshold Vth in, for example, the storage unit 131. The data determination threshold Vth is a normal data determination threshold with which the optical transceiver 1 operates normally in the absence of power supply noise. If noise is generated in a power supply voltage, the waveform of the noise is superposed on original waveforms of transmission signals and reception signals; that is, waveforms which are generated in the absence of power supply noise. Therefore, upon detection of a peak value ΔVp of the noise by the noise detection unit 14, the control unit 13 calculates a value Vth+ΔVp, which is obtained by adding the detected peak value ΔVp of the noise to the pre-stored data determination threshold Vth, and sets the calculated value as a data determination threshold which is to be used in actual determination in the receiving-side electrical waveform regeneration unit 22. In this way, since a value Vth+ΔVp is set as the data determination threshold which is to be used in actual determination, the data determination threshold is set to an optimum value depending on power supply noise. In this case, the optical transceiver 1 does not change the data determination threshold Vth pre-stored in the storage unit 131, and dynamically determines the data determination threshold that is actually used in accordance with the noise detection result by the noise detection unit 14. For this reason, the characteristics of products can be compensated for without changing data determination thresholds Vth which are set at the time of shipping the products.

In addition, if power supply noise is superposed on a drive current of a laser diode, the superposed power supply noise affects the characteristics of waveforms of optical signals to be transmitted, thereby deteriorating the transmission characteristics. Accordingly, the relationship between the amplitudes of power supply noise and optimum setting values of the drive current is set in advance, and this relationship is stored in, for example, a table. When power supply noise is detected, an optimum setting value of the drive current corresponding to the amplitude of the detected power supply noise is obtained from the table, and the obtained optimum setting value is set in the laser diode, thereby dynamically controlling the drive current of the laser diode. As a result, influences due to power supply noise can be avoided.

In addition, there are alternative methods other than the above-described method for setting the value Vth+ΔVp as a data determination threshold which is used in actual determination.

Specifically, a ROM (Read Only Memory) is provided which stores a table in which noise peak values are associated with data determination thresholds which may be actually used. The ROM can be configured, for example, as part of the storage unit 131. The control unit 13 calculates a data determination threshold which corresponds to a noise peak value detected by the noise detection unit 14 by means of interpolation based on information on the table stored in the ROM, and determines data in accordance with the calculated data determination threshold.

Alternatively, ranges of noise peak values are associated with data determination thresholds which may be used in actual determination, the ranges and the data determination thresholds are stored in a table provided in the ROM, and a data determination threshold is determined without performing interpolation. Specifically, the control unit 13 determines the data determination threshold which is associated with a range in which the detected noise peak value is included as a data determination threshold which is to be used in actual determination.

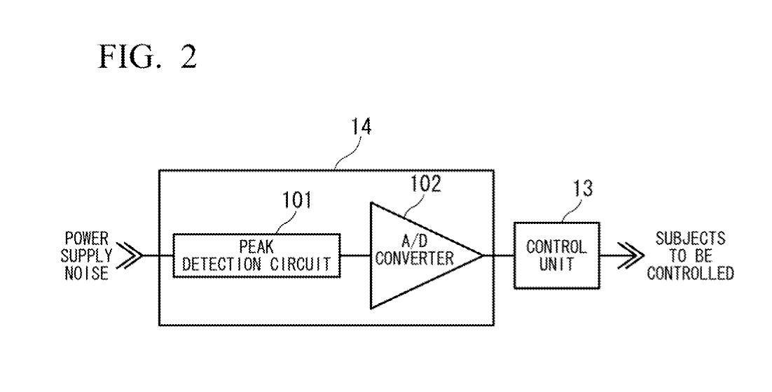

FIG. 2 is a block diagram showing the control unit 13 as well as an example of the structure of the noise detection unit 14 when the noise detection unit 14 is realized by an analog circuit.

As shown in FIG. 2, the noise detection unit 14 is provided with a peak detection circuit 101 and an A/D (Analog/Digital) converter 102. In FIG. 2, a power supply voltage fed from the power supply circuit 33 is supplied to the peak detection circuit 101. The peak detection circuit 101 detects a peak of the power supply voltage. A detected peak value output from the peak detection circuit 101 is supplied to the A/D converter 102, and the detected peak value of the power supply voltage, which is an analog value, is converted into a digital value by the A/D converter 102. An output of the A/D converter 102 is supplied to the control unit 13.

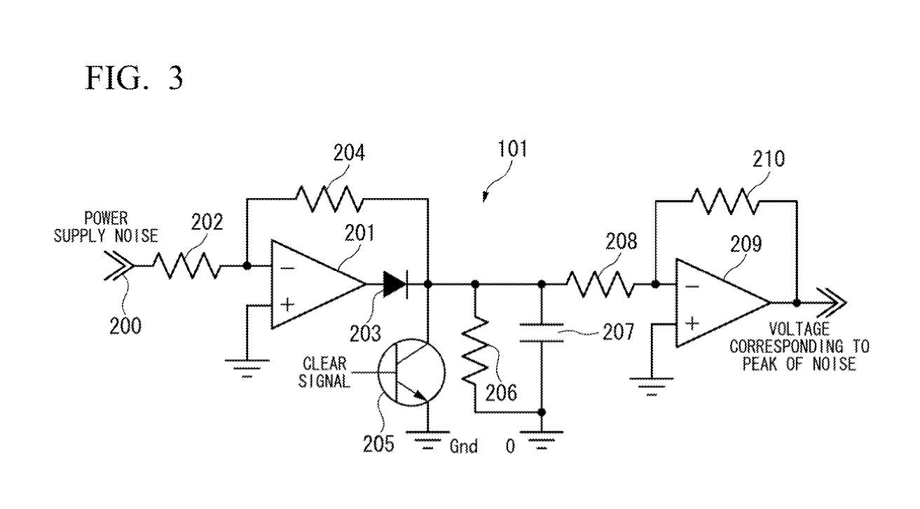

For example, the peak detection circuit 101 can be configured as shown in FIG. 3.

In FIG. 3, an inverting input terminal of an operational amplifier 201 is connected to an input terminal 200 via a resistor 202. A non-inverting input terminal of the operational amplifier 201 is grounded. An output terminal of the operational amplifier 201 is connected to an anode of a diode 203. A resistor 204 is interposed between a cathode of the diode 203 and the inverting input terminal of the operational amplifier 201. A detection circuit is configured by the operational amplifier 201, the resistor 202, the resistor 204, and the diode 203.

A transistor 205 is interposed between the cathode of the diode 203 and the ground. A resistor 206 and a capacitor 207 are interposed between the cathode of the diode 203 and the ground. The resistor 206 and the capacitor 207 smooth a detected output of the detection circuit configured by the operational amplifier 201, the resistor 202, the resistor 204, and the diode 203, and detect an envelope of the detected output. The transistor 205 is provided in order to clear (reset) the detected output in response to a given clear signal.

A wire which connects the cathode of the diode 203, the resistor 206, and the capacitor 207 with each other is also connected to an inverting input terminal of an operational amplifier 209 via a resistor 208. A non-inverting input terminal of the operational amplifier 209 is grounded. A resistor 210 is interposed between an output terminal of the operational amplifier 209 and the inverting input terminal of the operational amplifier 209. The resistor 208, the resistor 210, and the operational amplifier 209 configure a buffer amplifier which inversely amplifies a detected peak level value. A voltage corresponding to the peak of noise superposed on the power supply voltage is output from the output terminal of the operational amplifier 209.

As shown in FIG. 3, the peak detection circuit 101 of the noise detection unit 14 is configured by an analog circuit which includes the operational amplifier 201, the operational amplifier 209, the diode 203, the transistor 205, and the like. Owing to improvement in miniaturization and broadening of bandwidth for transistors, diodes, and operational amplifiers, these components can be realized in a minimum mounting area of several square millimeters. In addition, digital control circuits, such as a microcomputer which configures the control unit 13 and an A/D converter like the A/D converter 102, are normally pre-installed as internal circuits of optical transceivers, the miniaturization of which is advancing. Therefore, even when the control unit 13 and the noise detection unit 14 are installed in the optical transceiver 1, almost no extra components are required and an increase in the scale of circuits is small. Taking improvement in operating characteristics of A/D converters into consideration, it is possible for the noise detection unit 14 to detect noise having a peak-to-peak voltage of several tens mV.

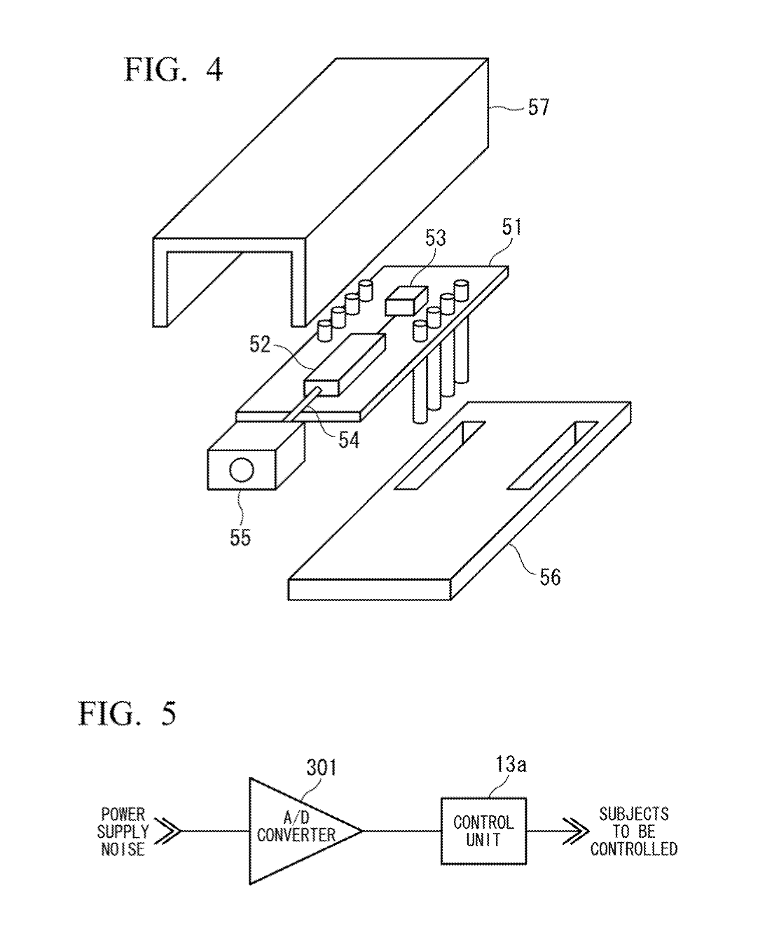

FIG. 4 shows an exploded perspective view of an example of the structure of the optical transceiver 1. As shown in FIG. 4, an optical module 52 and an IC (integrated circuit) chip 53 are mounted on a printed circuit board 51. The optical module 52 accommodates the optical receiver 21 and the optical transmitter 31 shown in FIG. 1. The IC chip 53 accommodates the receiving-side electrical waveform regeneration unit 22, the transmitting-side electrical waveform regeneration unit 32, the control unit 13, and the noise detection unit 14 shown in FIG. 1. The noise detection unit 14 may be configured by discrete components and mounted on the printed circuit board 51. In this case, the noise detection unit 14 is not accommodated in the IC chip 53. As described above, even when the noise detection unit 14 is configured by discrete components and mounted on the printed circuit board 51, an increase in the scale of circuits is small. The optical module 52 is connected to an optical receptacle 55 via an optical fiber 54. The printed circuit board 51 is placed on a base plate 56. The printed circuit board 51, the optical module 52, the IC chip 53, and the optical fiber 54 are sealed with a case 57.

As described above in detail, in the first exemplary embodiment of the present invention, the noise detection unit 14 is installed in the optical transceiver 1. The noise detection unit 14 detects power supply noise and feeds the noise detection result back to the control unit 13. As a result, subjects controlled by the control unit 1 (e.g., the data determination threshold of the receiving-side electrical waveform regeneration unit 22 provided in the optical reception circuit 11, the drive current of the laser diode which configures the optical transmitter 31 provided in the optical transmission circuit 12, and the like) can be set optimally in accordance with the noise detection result.

It is noted that the optical transceiver 1 can be configured as shown in FIG. 5. In this case, an A/D converter 301 acquires values of a power supply voltage. A control unit 13a provides the following functions in addition to the above-described functions provided by the control unit 13. Specifically, the control unit 13a detects a voltage that exceeds a preset voltage as the power supply noise and counts the number of power supply noises detected in a predetermined period of time. The obtained count value corresponds to amplitude components and frequency components of the power supply noises. The control unit 13a associates count values with optimum values of the data determination threshold and the drive current of the laser diode, and pre-stores them in the storage unit 131 as, for example, a table. The control unit 13a searches this table for optimum values associated with the obtained count value, and sets the obtained optimum values in subjects to be controlled. Accordingly, the A/D converter 301 and a portion of the control unit 13a that provides the functions unique to the control unit 13a can be generally referred to as a noise detection unit. In addition, the remaining portion of the control unit 13a that provides the same functions as those of the control unit 13 can be generally referred to as a control unit.

While the present invention has been particularly shown and described with reference to exemplary embodiments thereof, the present invention is not limited to these exemplary embodiments. It will be understood by those of ordinary skill in the art that various changes in form and details may be made therein without departing from the spirit and scope of the present invention as defined by the claims.

What is claimed is:

1. An optical transceiver comprising:
an optical reception circuit which converts a first optical signal received from an optical cable into a first electrical data signal and outputs the first electrical data signal;
an optical transmission circuit which converts a second electrical data signal into a second optical signal and outputs the second optical signal to the optical cable;
a noise detection unit which detects power supply noise from a power supply voltage; and
a control unit which sets at least one of operational characteristics of the optical reception circuit and operational characteristics of the optical transmission circuit in accordance with a detection result of the noise detection unit.

2. The optical transceiver according to claim 1, wherein the noise detection unit detects a level of a peak of the power supply voltage and detects the power supply noise from the level of the peak.

3. The optical transceiver according to claim 1, wherein the noise detection unit detects a power supply voltage which exceeds a preset voltage as the power supply noise.

4. The optical transceiver according to claim 3, further comprising a storage unit which stores the number of power supply noises and at least one of the operational characteristics of the optical reception circuit and the operational characteristics of the optical transmission circuit, the number of the power supply noises being associated with the at least one of the operational characteristics of the optical reception circuit and the operational characteristics of the optical transmission circuit,
wherein the control unit obtains the number of power supply noises detected in a predetermined period of time, and sets, in at least one of the optical reception circuit and the optical transmission circuit, the at least one of the operational characteristics of the optical reception circuit and the operational characteristics of the optical transmission circuit which are stored in the storage unit in association with the obtained number of power supply noises.

5. The optical transceiver according to claim 1, wherein the operational characteristics of the optical reception circuit include a data determination threshold used by the optical reception circuit.

6. The optical transceiver according to claim 1, wherein the optical transmission circuit is provided with a laser diode, and
the operational characteristics of the optical transmission circuit include a drive current of the laser diode.

7. The optical transceiver according to claim 5, further comprising a storage unit which stores a normal data determination threshold which is a data determination threshold when the optical transceiver operates normally in the absence of the power supply noise,
wherein the control unit determines the data determination threshold used by the optical reception circuit based on the normal data determination threshold and the detection result of the noise detection unit.

8. The optical transceiver according to claim 7, wherein the noise detection unit detects a level of a peak of the power supply noise, and
the control unit sets a value obtained by adding the normal data determination threshold to the level of the peak of the power supply noise, as the data determination threshold used by the optical reception circuit.

9. The optical transceiver according to claim 5, further comprising a storage unit which stores a peak value of the power supply noise and a data determination threshold value, the peak value being associated with the data determination threshold value,
wherein the control unit sets the data determination threshold used by the optical reception circuit based on the peak value and the data determination threshold value which are stored in the storage unit and on a level of a peak of the power supply noise indicated by the detection result of the noise detection unit.

10. The optical transceiver according to claim 9, wherein the control unit calculates a data determination threshold corresponding to the level of the peak of the power supply noise by means of interpolation, and sets the calculated data determination threshold as the data determination threshold used by the optical reception circuit.

11. The optical transceiver according to claim 5, further comprising a storage unit which stores a range of a level of a peak of the power supply noise and a data determination threshold value, the range being associated with the data determination threshold value,
wherein the control unit sets a data determination threshold value which is stored in the storage unit in association with a range in which the level of the peak of the power supply noise is included, as the data determination threshold used by the optical reception circuit.

12. The optical transceiver according to claim 1, wherein the noise detection unit is provided with:
an analog peak detection circuit which detects a level of a peak of the power supply voltage; and
an analog/digital conversion circuit which converts the level of the peak into a digital signal.

13. The optical transceiver according to claim 1, wherein the optical reception circuit is provided with:
an optical receiver which receives the first optical signal from the optical cable; and
a receiving-side electrical waveform regeneration unit which converts the received first optical signal into the first electrical data signal,
the optical transmission circuit is provided with:
a transmitting-side electrical waveform regeneration unit which regenerates the second electrical data signal; and
an optical transmitter which converts an output of the transmitting-side electrical waveform regeneration unit into the second optical signal, and transmits the second optical signal to the optical cable, and
the optical transceiver is further provided with:
an optical module which accommodates the optical receiver and the optical transmitter;
an integrated-circuit chip which accommodates the receiving-side electrical waveform regeneration unit, the transmitting-side electrical waveform regeneration unit, the noise detection unit, and the control unit; and
a printed circuit board on which the optical module and the integrated-circuit chip are mounted.

14. The optical transceiver according to claim 1, wherein the optical reception circuit is provided with:
an optical receiver which receives the first optical signal from the optical cable; and
a receiving-side electrical waveform regeneration unit which converts the received first optical signal into the first electrical data signal,
the optical transmission circuit is provided with:
a transmitting-side electrical waveform regeneration unit which regenerates the second electrical data signal; and
an optical transmitter which converts an output of the transmitting-side electrical waveform regeneration unit into the second optical signal, and transmits the second optical signal to the optical cable,
the noise detection unit is configured by a discrete component, and
the optical transceiver is further provided with:
an optical module which accommodates the optical receiver and the optical transmitter;
an integrated-circuit chip which accommodates the receiving-side electrical waveform regeneration unit, the transmitting-side electrical waveform regeneration unit, and the control unit; and
a printed circuit board on which the noise detection unit, the optical module and the integrated-circuit chip are mounted.

15. A method for controlling an optical transceiver, the method comprising:
detecting power supply noise of an optical transceiver which is provided with an optical reception circuit which converts a first optical signal received from an optical cable into a first electrical data signal and outputs the first electrical data signal, and an optical transmission circuit which converts a second electrical data signal into a second optical signal and transmits the second optical signal to the optical cable; and
setting at least one of operational characteristics of the optical transmission circuit and operational characteristics of the optical reception circuit in accordance with a detection result of the power supply noise.
